(19) United States
(12) Patent Application Publication
(10) Pub. No.: US 2025/0265936 A1
(43) Pub. Date: Aug. 21, 2025

(54) Detecting Conflict Along a Route of a Robot

(71) Applicant: Aurora Flight Sciences Corporation, a subsidiary of The Boeing Company, Manassas, VA (US)

(72) Inventors: Margaret Reagan, Cambridge, MA (US); Jeffery Saunders, Quincy, MA (US); William R. Bosworth, Somerville, MA (US)

(21) Appl. No.: 17/148,127

(22) Filed: Jan. 13, 2021

Related U.S. Application Data
(60) Provisional application No. 63/059,393, filed on Jul. 31, 2020.

(51) Int. Cl. G08G 5/04; G05D 1/00; G05D 1/02; G08G 5/00

(52) U.S. Cl. CPC G08G 5/80; G08G 5/53; G08G 5/55; G08G 5/57

(57) ABSTRACT

A method is provided for detecting conflict along a route for a robot to travel. The method includes generating a predicted trajectory of a nearby moving object, generating a trajectory of the robot, and performing a comparison of the nearby moving object and the robot on their projected trajectory and trajectory to detect a conflict that may be avoided. The comparison includes determining updated positions and velocities of the nearby moving object and the robot. The comparison also includes determining if the nearby moving object is within a clear region that includes the robot from the updated positions, and if a time to closest point of approach between nearby moving object and the robot is less than a time threshold value from the updated velocities. The conflict is then detected when the nearby moving object is within the clear region, and the time to closest point of approach is less than the time threshold value.

### TECHNOLOGICAL FIELD

The present disclosure relates generally to robotics and, in particular, to one or more of the design, construction, operation or use of autonomous robots such as autonomous or semi-autonomous vehicles.

### BACKGROUND

Many modern robots and other machines are designed to operate with increased autonomy and are less reliant on well-trained operators to safely operate. Some of these modern robots are manned while others are unmanned. In particular, a variety of unmanned vehicles include unmanned ground vehicles (UGVs), unmanned aerial vehicles (UAVs), unmanned surface vehicles (USVs), unmanned underwater vehicles (UUVs), unmanned spacecraft and the like. The use of unmanned vehicles has grown in recent years and these unmanned vehicles are employed in a wide variety of applications, including both military and civilian uses.

One focus in the field of robotics is in the improvement of autonomy, which often includes multiple aspects of robot operation. These aspects of robot operation include automatic control of a given robot to support remote human control. Another aspect is optimization systems (and associated methods) to determine how, for a given robot or set of robots, tasks should be ordered and/or allocated. And yet another aspect of robot operation is automatic, real-time or near real-time data processing, and exploitation in support of automatic route planning, mission execution and other activities.

Despite advancements, existing autonomy systems are typically configured to address only one aspect of these activities, thereby focusing its design of the underling autonomy algorithms and software architecture on a narrow mission set. This limits the extensibility of existing autonomy systems, as they are not well-equipped to support the addition of new modules to the autonomy system. Furthermore, existing autonomy systems may or may not be structured for rapid adaptation to new platforms through parameterization.

Therefore it would be desirable to have a system and method that takes into account at least some of the issues discussed above, as well as other possible issues.

### BRIEF SUMMARY

Example implementations of the present disclosure are directed to conflict detection along a route for a robot to travel. Some example implementations use track generation to generate trajectories of one or more nearby moving objects and the robot, and conflict detection to detect a conflict using the trajectories. Sensor data may be acquired by a variety of different sensors (e.g., radar, lidar, infrared sensor, camera, ADS-B), and filtered and/or correlated from multiple observations for a nearby moving object. The sensor data may be used to generate a straight-line, vector projection for a nearby moving object into the future for an amount of time.

This vector projection may correspond to a predicted trajectory of the nearby moving object, which may be assessed to determine if the projected trajectory has the potential to cause a conflict. This conflict detection may generate a trajectory of the robot, which in some examples may be on a route provided by a pre-defined route command or flight plan. The assessment may use a clear region (e.g., well-clear region, boundary, violation volume) that includes the robot, and in some examples, the clear region may be dynamic in size, which may account sensor uncertainty, distance in the future the conflict may occur, and the like. The overall strategy for track generation and conflict detection may allow different sources of position and velocity data for a moving object to be used to generate an accurate predicted trajectory of the moving object for conflict detection.

The present disclosure thus includes, without limitation, the following example implementations.

Some example implementations provide a method of detecting conflict along a route for a robot to travel, the method comprising receiving first data that indicates a first position and a first velocity of one or more nearby moving objects, or from which the first position and the first velocity of the one or more nearby moving objects are determined; and for each nearby moving object of the one or more nearby moving objects, generating a vector projection of the nearby moving object from the first position and using the first velocity of the nearby moving object, the vector projection corresponding to a predicted trajectory of the nearby moving object; generating a trajectory of the robot on the route for the robot to travel, and from second data that indicates a second position and a second velocity of the robot; performing a comparison of the nearby moving object and the robot on respectively the predicted trajectory of the nearby moving object and the trajectory of the robot, the comparison performed to detect a conflict when the nearby moving object is within a clear region that includes the robot, and a time to closest point of approach between nearby moving object and the robot is less than a time threshold value; and when the conflict is detected, outputting an indication of the conflict for use in at least one of guidance, navigation or control of the robot to avoid the conflict.

In some example implementations of the method of any preceding example implementation, or any combination of any preceding example implementations, the route for the robot to travel is described by at least one of a route command, a flight plan or a mission route, and generating the trajectory of the robot includes generating the trajectory of the robot using the at least one of the route command, the flight plan or the mission route.

In some example implementations of the method of any preceding example implementation, or any combination of any preceding example implementations, receiving the first data comprises receiving the first data from a sensor operatively in communication with the robot and having a first data format, or data-linked from the nearby moving object and having a second data format; and transforming the first data from the first data format or the second data format to a third data format from which the vector projection and thereby the predicted trajectory of the nearby moving object is generated.

In some example implementations of the method of any preceding example implementation, or any combination of any preceding example implementations, the method further comprises applying the first data to a filter that passes the first data for generating the vector projection only when the first position of the nearby moving object is within a given region of interest that includes the robot at the second position.

In some example implementations of the method of any preceding example implementation, or any combination of any preceding example implementations, the first data further indicates a time and an accuracy of the first data, and the method further comprises applying the first data to a filter that passes the first data for generating the vector projection only when the time is within a time threshold of current time, and the accuracy is within an accuracy threshold.

In some example implementations of the method of any preceding example implementation, or any combination of any preceding example implementations, the first position and the first velocity are observations of position and velocity, and receiving the first data comprises receiving data from multiple sources including respective observations of position and velocity of the one or more nearby moving objects; correlating the respective observations of position and velocity; and based on the respective observations having at least a threshold degree of correlation that indicates the respective observations are for the nearby moving object, selecting an observation of position and velocity from the respective observations as the respectively first position and the first velocity of the nearby moving object.

In some example implementations of the method of any preceding example implementation, or any combination of any preceding example implementations, the first data further indicates accuracies of the respective observations of position and velocity, and selecting the observation includes selecting the observation that is most accurate as indicated by a highest one of the accuracies.

In some example implementations of the method of any preceding example implementation, or any combination of any preceding example implementations, the one or more nearby moving objects are a plurality of nearby moving objects, and wherein the method further comprises applying the first data to a filter that passes the first data for generating the vector projection for only a given number of the plurality of nearby moving objects, and the vector projection and thereby the predicted trajectory of the nearby moving object is generated for each nearby moving object.

In some example implementations of the method of any preceding example implementation, or any combination of any preceding example implementations, performing the comparison includes performing a stepwise comparison that includes a plurality of timesteps, and the clear region is dynamic in size in that the clear region is different in size for a later one of the plurality of timesteps relative to an earlier one of the plurality of timesteps.

In some example implementations of the method of any preceding example implementation, or any combination of any preceding example implementations, the method further comprises determining at least one maneuver to avoid the conflict; and causing the robot to execute the at least one maneuver.

Some example implementations provide an apparatus for detecting conflict along a route for a robot to travel, the apparatus comprising a memory having computer-readable program code stored therein; and processing circuitry configured to access the memory, and execute the computer-readable program code to cause the apparatus to at least perform the method of any preceding example implementation, or any combination of any preceding example implementations.

Some example implementations provide a computer-readable storage medium for detecting conflict along a route for a robot to travel, the computer-readable storage medium being non-transitory and having computer-readable program code stored therein that, in response to execution by processing circuitry, causes an apparatus to at least perform the method of any preceding example implementation, or any combination of any preceding example implementations.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates one type of robot, namely, an unmanned aerial vehicle, that may benefit from example implementations of the present disclosure;

FIG. 2 illustrates a system according to some example implementations;

FIG. 3 more illustrates a mission management system (MMS) according to some example implementations;

FIG. 4 illustrates a scenario in which the robot is executing a mission in which the robot is to travel on a route in an environment in which one or more moving objects are nearby the robot, according to some example implementations;

FIG. 5 is a diagram of services that may be implemented by the MMS for conflict detection and avoidance with respect to one or more nearby moving objects, according to some example implementations;

FIG. 6 is a diagram of a simulated track management service that may be implemented by the MMS, according to some example implementations;

FIGS. 7A, 7B, 7C, 7D and 7E are flowcharts illustrating various steps in a method of detecting conflict along a route for a robot to travel, according to example implementations; and

FIG. 8 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless specified otherwise or clear from context, references to first, second or the like should not be construed to imply a particular order. A feature may be described as being above another feature (unless specified otherwise or clear from context) may instead be below, and vice versa; and similarly, features described as being to the left of another feature else may instead be to the right, and vice versa. As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Like reference numerals refer to like elements throughout. Furthermore, it should be understood that unless otherwise specified, the terms “data,” “content,” “digital content,” “information,” and similar terms may be at times used interchangeably.

Example implementations of the present disclosure relate generally to robotics and, in particular, to one or more of the design, construction, operation or use of robots. As used herein, a robot is a machine designed and configurable to execute maneuvers in its environment. The robot may be manned or unmanned. The robot may be fully human-controlled, or the robot may be semi-autonomous or autonomous in which at least some of the maneuvers are executed independent of or with minimal human intervention. In some examples, the robot is operable in various modes with various amounts of human control.

A robot designed and configurable to fly may at times be referred to as an aerial robot. A robot designed and configurable to operate with at least some level of autonomy may at times be referred to as an autonomous robot, or an autonomous aerial robot in the case of an autonomous robot that is also designed and configurable to fly. Examples of suitable robots include aerobots, androids, automatons, autonomous vehicles, explosive ordnance disposal robots, hexapods, industrial robots, insect robots, microbots, nanobots, military robots, mobile robots, rovers, service robots, surgical robots, walking robots and the like. Other examples include a variety of unmanned vehicles, including unmanned ground vehicles (UGVs), unmanned aerial vehicles (UAVs), unmanned surface vehicles (USVs), unmanned underwater vehicles (UUVs), unmanned spacecraft and the like. These may include autonomous cars, planes, trains, industrial vehicles, fulfillment center robots, supply-chain robots, robotic vehicles, mine sweepers, and the like.

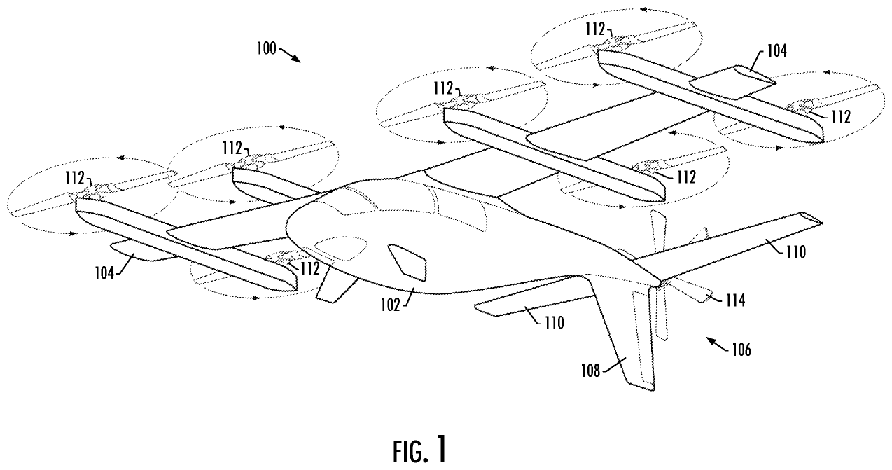

FIG. 1 illustrates one type of robot, namely, a UAV 100, that may benefit from example implementations of the present disclosure. As shown, the UAV generally includes a fuselage 102, wings 104 extending from opposing sides of the UAV in a mid-section of the fuselage, and an empennage or tail assembly 106 at a rear end of the fuselage. The tail assembly includes a vertical stabilizer 108 and two horizontal stabilizers 110 extending from opposing sides of the UAV. Rotors 112 and 114 are mounted to respectively the wings and the end of the tail assembly for lifting and propelling the UAV during flight.

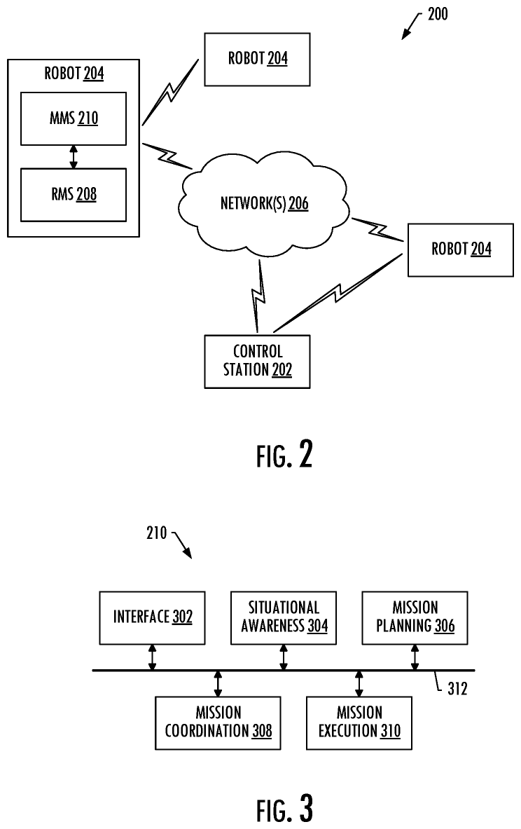

FIG. 2 illustrates a system 200 according to some example implementations of the present disclosure. The system may include any of a number of different subsystems (each an individual system) for performing one or more functions or operations. As shown, in some examples, the system includes a control station 202 and one or more robots 204 (e.g., one or more UAVs 100). The control station provides facilities for communication with or control of the one or more robots, such as by wired or wireless data links directly or across one or more networks 206. In some examples, the control station may be a ground station, and not in all cases control the robots. In this regard, the control station may be configured to monitor the robots. The control station may initiate mission, but the control station may not control the robots to maneuver. At times, then, the control station may enable or provide a distributed network/server of software functions.

The robot 204 includes a robot management system (RMS) 208 and a mission management system (MMS) 210. The RMS is a robot-specific subsystem configured to manage subsystems and other components of the robot. These subsystems and other components include, for example, maneuver controls, landing gear, onboard environmental systems, electrical, pneumatic and hydraulic systems, communications systems, navigation systems and other subsystems and components for controlling operation and maneuvering of the robot. The RMS is configured to accept maneuver commands such as waypoints and/or steering commands, and control the robot to follow those maneuver commands. In the context of a vehicle, the RMS is at times referred to as a vehicle management system (VMS).

The MMS 210 is a subsystem configured to manage missions of the robot 204. A mission is a deployment of the robot (one or more robots) to achieve one or more mission objectives. A mission may be decomposed into maneuvers of the robot with optional sensor and/or effector scheduling, and the MMS may execute tasks to manage the robot to execute maneuvers with specific parameters and capabilities. The MMS 210 includes subsystems to process sensor data to situational awareness, plan tasks for the robot 204 (or multiple robots), coordinate with teams to assign tasks, execute assigned tasks. The MMS is also configured to interface with the RMS 208, and in some examples the control station 202. Although the MMS is shown on the robot 204, the MMS may instead be at the control station; or in some examples, the MMS may be distributed between the robot and the control station.

In some examples, the MMS 210 provides a complete, end-to-end autonomy architecture with open system architecture standards and parameterized to allow rapid extension and reapplication to a variety of robots. The flexibility of the MMS enables an operator to code it once, but to apply it anywhere. The MMS may therefore be applied to virtually any robot that applies, or benefits from, autonomy. The MMS may include an adaptable autonomy architecture that is applicable to a variety of robots, including those identified above. A benefit of the MMS is therefore not only in the specific contents, but also in the specific details of the architecture, its subroutines, and in the interfaces between those subroutines and other systems/devices that support rapid extensibility and adaptability of the MMS to a variety of domains.

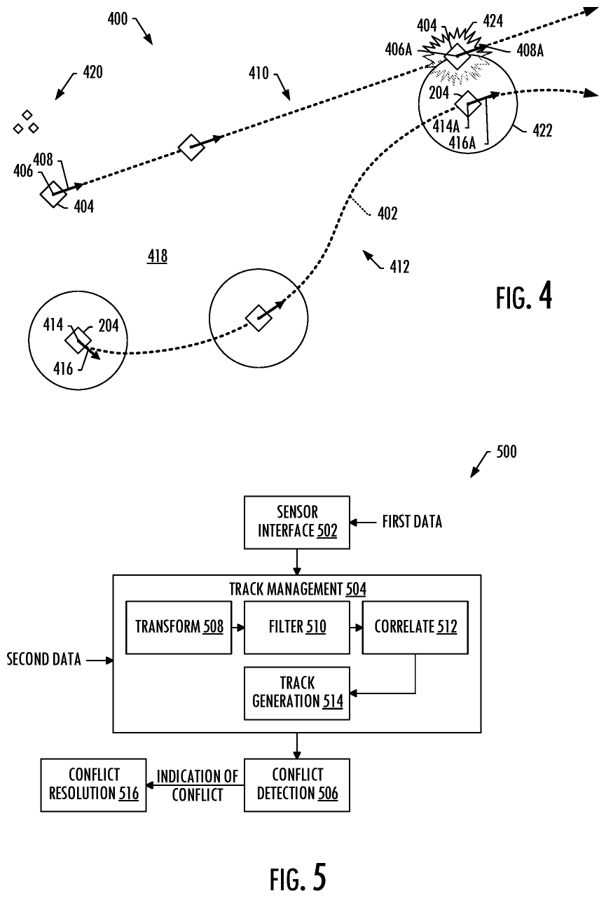

FIG. 3 more particularly illustrates the MMS 210 according to some example implementations of the present disclosure. The MMS may include any of a number of different subsystems (each an individual system) for performing one or more functions or operations. As shown, in some examples, the MMS includes an interface subsystem 302, a situational awareness subsystem 304, a mission planning subsystem 306, a mission coordination subsystem 308, and a mission execution subsystem 310. As suggested above, in some examples, the subsystems of the MMS may be on the robot 204, at the control station 202, or distributed between the robot and the control station. The subsystems may be configured to communicate with one another directly, over a communication bus 312, or across the network(s) 206 in examples in which the MMS is distributed between the robot and the control station.

The subsystems enable the MMS 210 of the robot 204 to interface with the system 200, perform situational awareness, plan a mission including a plurality of tasks, coordinate the plurality of tasks and thereby the mission with other robots 204, and execute the mission. For example, the MMS may use the interface subsystem 302 to interface with various sensors onboard the robot, the RMS 208, the control station 202 and/or other robots. The MMS may use the situational awareness subsystem 304 to acquire sensor data and maintain an awareness of the state of the environment in which the robot is operating. The MMS may use the mission planning subsystem 306 to plan a mission including or associated with a plurality of tasks, and which may incorporate rules of engagement, tactics and other constraints on operations. The MMS may likewise use the mission planning subsystem to dynamically replan a mission in which changes to the mission are made in real-time or near real-time as the mission is executed. The MMS may use the mission coordination subsystem 308 to coordinate the plurality of tasks of the mission with other robots and users, where agreed-upon tasks may then be executed by the MMS using the mission execution subsystem 310.

According to some example implementations of the present disclosure, the MMS 210 is also configured to implement software functionality or functionalities (at times referred to as services) during a mission to provide the robot 204 with conflict detection and avoidance capabilities. During a mission, the robot may take a path, and this path may be described by a series of waypoints that define a route the robot will travel. The robot travels with a velocity (speed and direction of motion), and the series of waypoints and velocities at that define the route with respect to time defines a trajectory of the robot (at times referred to as a track of the robot). The conflict detection and avoidance capabilities enable the robot to detect and avoid conflicts along its route of travel.

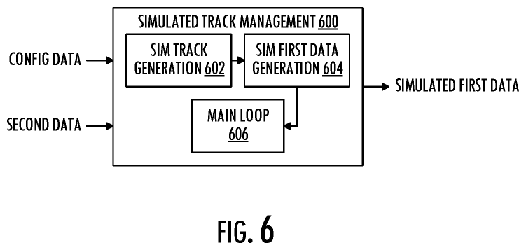

FIG. 4 illustrates a scenario 400 in which the robot 204 is executing a mission in which the robot is to travel on a route 402 in an environment in which one or more moving objects 404 are nearby the robot. In some examples, these moving objects are other robots that may be of the same type or different types than the robot. Other examples of suitable moving objects include non-robot vehicles such as any of a number of different types of ground vehicles, watercraft, aircraft, spacecraft or the like.

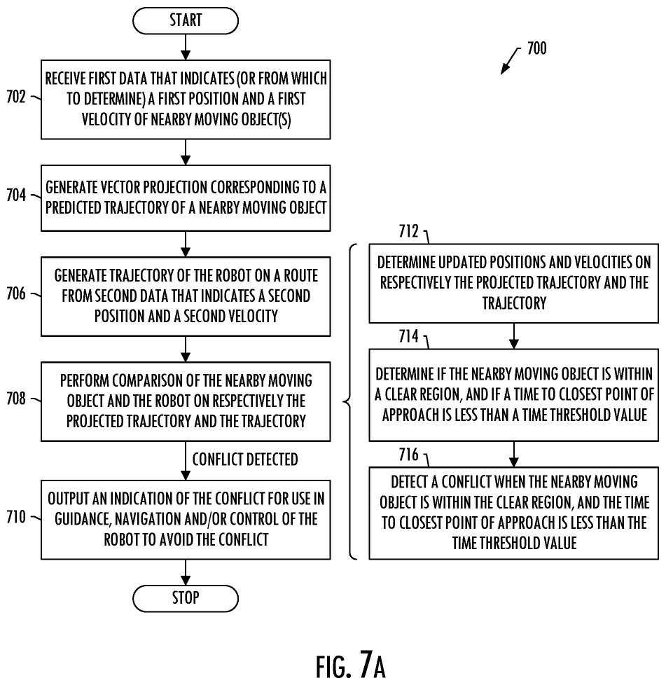

FIG. 5 is a diagram of services 500 that may be implemented by the MMS 210 for conflict detection and avoidance with respect to nearby moving objects 404, according to some example implementations. As shown, the services may include a sensor interface 502 service, track management 504 service and conflict detection 506 service. In some examples, the sensor interface service may be implemented by the interface subsystem 302 of the MMS. Also in some examples, the track management service and the conflict detection service may be implemented by respective ones of the situational awareness subsystem 304 and the mission execution subsystem 310 of the MMS.

According to example implementations, the sensor interface 502 service is configured to receive first data that indicates a first position 406 and a first velocity 408 of the nearby moving object(s) 404, or the first position and the first velocity are determined from the first data. The first data may include sensor data from any of a number of different sensors including those employing technologies such as acoustics, radio, optics and the like. More particular examples of suitable sensors include those employing radar, lidar, infrared sensors, cameras and the like. Another example of a suitable sensor in the context of an aerial robot is an automatic, dependent surveillance-broadcast (ADS-B) receiver configured to receive ADS-B signals. In some examples, the first data is from a sensor operatively in communication with the robot 204 and has a first data format (e.g., radar), or data-linked from the nearby moving object(s) 404 and having a second data format (e.g., ADS-B).

A number of sensors such as those employing radar, lidar, infrared sensors, cameras and the like generate images from reflected electromagnetic waves (e.g., radio, infrared radiation, visible light) or mechanical waves (e.g., sound waves). These images may be used to detect the presence and position of a nearby moving object 404; and in some examples, the nearby moving object may also be identified. The images may also be used to track the nearby moving object using multiple sequential detections over time, which may in turn be used to determine its velocity.

ADS-B is a surveillance technology for tracking aircraft that uses satellite-based navigation technology and a broadcast communications data-link (ADS-B unit). A nearby moving object 404 that is an ADS-B capable aircraft may use a satellite-based navigation receiver to derive its precise position from satellites, and combine that position with state information such as velocity, altitude and flight number. The nearby moving object/aircraft may then broadcast this information via an ADS-B signal to other ADS-B capable systems, which may include the robot 204.

The track management 504 service and the conflict detection 506 service are configured to perform a number of operations for each nearby moving object 404 of the nearby moving object(s). In various examples, the track management service includes one or more sub-services (each an individual service) such as a transform 508 service, a filter 510 service, a correlate 512 service and/or a track generation 514 service. The track generation service is configured to generate a vector projection of the first velocity 408 of the nearby moving object from the first position 406 of the nearby moving object. This vector projection corresponds to a predicted trajectory 410 of the nearby moving object.

The track generation 514 service of the track management 504 service is also configured to generate a trajectory 412 of the robot 204 on the route 402, from second data that indicates a second position 414 and a second velocity 416 of the robot. The second data may include state data that describes position and velocity of the robot, and which in some examples may be received from the RMS 208. In some examples, the route for the robot is described by a route command, a flight plan (for an aerial robot) and/or a mission route; and in some of these examples, the trajectory of the robot is generated using the route command, the flight plan and/or the mission route. In this regard, the route in some examples is a planned route of the robot.

In some examples in which the first data has a first data format or a second data format, the transform 508 service is configured to transform the first data to a third data format. The filter 510 service is configured to apply the first data to one or more filters before the vector projection for the predicted trajectory 410 is generated. In some examples, the filter service is configured to apply the first data to a filter that passes the first data for generation of the vector projection only when the first position 406 of the nearby moving object 404 is within a given region of interest 418 that includes the robot 204 at the second position 414. In some examples, the first data further indicates a time and an accuracy of the first data, and the filter service is configured to apply the first data to a filter that passes the first data for generation of the vector projection only when the time is within a time threshold of current time, and the accuracy is within an accuracy threshold. In some examples in which there are a plurality of nearby moving objects 420, and the filter 510 service is configured to apply the first data to a filter that passes the first data for generation of the vector projection for only a given number of the plurality of nearby moving objects.

In some examples, the first position 406 and the first velocity 408 of the nearby moving object 404 are observations of position and velocity, and the first data includes data from multiple sources including respective observations of position and velocity of the nearby moving object(s). The correlate 512 service is configured to correlate the respective observations of position and velocity; and in some examples, the respective observations have at least a threshold degree of correlation that indicates the respective observations are for the nearby moving object (e.g., a single nearby moving object that is the nearby moving object). Based on this threshold degree of correlation, the correlate service is configured to select an observation of position and velocity from the respective observations as the respectively first position and the first velocity of the nearby moving object. In some further examples, the first data further indicates accuracies of the respective observations of position and velocity, and the correlate service is configured to select the observation that is most accurate as indicated by a highest one of the accuracies.

The conflict detection 506 service of the services 500 that may be implemented by the MMS 210 is configured to perform a comparison of the nearby moving object 404 and the robot 204 on respectively the predicted trajectory 410 of the nearby moving object and the trajectory 412 of the robot. The comparison is performed to detect a conflict when the nearby moving object is within a clear region 422 that includes the robot, and a time to closest point of approach between nearby moving object and the robot is less than a time threshold value.

In some examples, conflict detection 506 service is configured to perform a stepwise comparison. In some of these examples, for a timestep of a plurality of timesteps (or for each timestep), the conflict detection service is configured to determine updated positions 406A, 414A and updated velocities 408A, 416A of the nearby moving object and the robot on respectively the predicted trajectory of the nearby moving object and the trajectory of the robot.

For the nearby moving object 404 and the robot 204 at respective ones of the updated positions 406A, 414A and the updated velocities 408A, 416A, the conflict detection 506 service is configured to determine if the nearby moving object is within a clear region 422 that includes the robot. The conflict detection service is also configured to determine if a time to closest point of approach between nearby moving object and the robot is less than a time threshold value. The clear region in various examples may be referred to as a well-clear region, boundary, violation volume or the like. In some examples, the clear region is dynamic in size in that the clear region is different in size for a later one of the plurality of timesteps relative to an earlier one of the plurality of timesteps. This may accommodate for uncertainty in the first data, distance in the future the conflict may occur, and the like.

The conflict detection 506 service is configured to detect a conflict 424 when the nearby moving object 404 is within the clear region 422, and the time to closest point of approach is less than the time threshold value. When the conflict is detected, the conflict detection service is configured to output an indication of the conflict for use in at least one of guidance, navigation or control of the robot to avoid the conflict. In some examples, the services 500 that may be implemented by the MMS 210 for conflict and detection may further include a conflict resolution 516 service, which may more particularly be implemented by the mission execution subsystem 310 of the MMS. In some of these examples, the conflict resolution service is configured to determine at least one maneuver to avoid the conflict, and the MMS is configured to cause the robot 204 to execute the at least one maneuver. This may include the MMS configured to send one or more maneuver commands to the RMS 208 to control the robot to follow the maneuver commands and thereby execute the at least one maneuver.

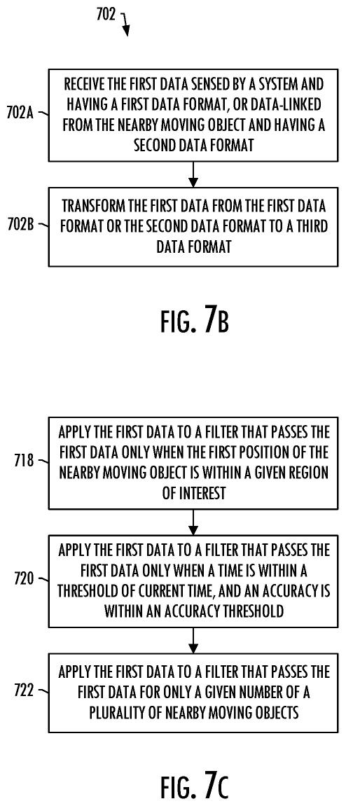

In some example implementations of the present disclosure, it may be useful to supply various services that may be implemented by the MMS 210 with simulated data that indicates position and velocity of one or more simulated moving objects. These services may include the services 500 for conflict detection and avoidance in which case the simulated data may be simulated first data received and processed in a manner similar to the first data as described above. FIG. 6 illustrates a simulated track management 600 service that may be implemented by the MMS such as by the mission planning subsystem 306 or the mission execution subsystem 310, according to some example implementations.

As shown, the simulated track management 600 service includes one or more sub-services (each an individual service) such as a simulated track generation 602 service, a simulated first data generation 604 service and/or a main loop 606 service. The simulated track generation service is configured to generate a trajectory of a simulated moving object, which may be defined by a series of waypoints (positions) and velocities of the simulated moving object. The trajectory of the simulated moving object may follow a random route, or the route may be pre-defined and provided by configuration data. In some examples, a conflict may be specified for the simulated moving object; and in some of these examples, the simulated track generation service may generate the trajectory of the simulated moving object further using a route of the robot 204, and/or the state data that describes the position and velocity of the robot, and that may be provided by the second data.

The simulated first data generation 604 service is configured to generate simulated first data from the trajectory of the simulated moving object. Similar to the first data described above, the simulated first data indicates position and velocity of the simulated moving object, or the position and the velocity are determined from the simulated first data. The simulated first data may be formatted as sensor data (e.g., radar, lidar, infrared sensor, camera, ADS-B) and expressed in any of a number of data formats (e.g., first data format, second data format). In some examples, the simulated first data may further include an amount of acceptable noise that may otherwise be expected of the first data.

The main loop 606 service is configured to publish the simulated first data such as for other services (e.g., services 500). In some examples, the main loop service is configured to publish the simulated first data based on the route of the robot 204, and/or the state data that describes the position and velocity of the robot. In this regard, the main loop service may publish the simulated first data when the position of the simulated moving object is within the given region of interest 418 that includes the robot, or when the simulated moving object is otherwise considered nearby the robot.

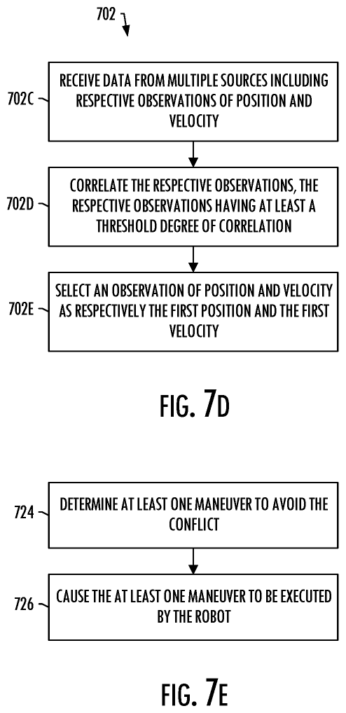

FIGS. 7A, 7B, 7C, 7D and 7E are flowcharts illustrating various steps in a method 700 of detecting conflict along a route for a robot to travel, according to example implementations of the present disclosure. As shown at block 702 of FIG. 7A, the method includes receiving first data that indicates a first position and a first velocity of one or more nearby moving objects, or from which the first position and the first velocity of the one or more nearby moving objects are determined. The method then includes a number of steps for each nearby moving object of the one or more nearby moving objects. In this regard, the method includes generating a vector projection of the nearby moving object from the first position and using the first velocity of the nearby moving object, the vector projection corresponding to a predicted trajectory of the nearby moving object, as shown at block 704.

The method 700 includes generating a trajectory of the robot on the route for the robot to travel, and from second data that indicates a second position and a second velocity of the robot, as shown at block 706. In some examples, the route for the robot to travel is described by at least one of a route command, a flight plan or a mission route; and in some of these examples, the trajectory of the robot is generated using the at least one of the route command, the flight plan or the mission route.

As shown at block 708, the method 700 includes performing a comparison of the nearby moving object and the robot on respectively the predicted trajectory of the nearby moving object and the trajectory of the robot. The comparison is performed to detect a conflict when the nearby moving object is within a clear region that includes the robot, and a time to closest point of approach between nearby moving object and the robot is less than a time threshold value. The method then includes, when the conflict is detected, outputting an indication of the conflict for use in at least one of guidance, navigation or control of the robot to avoid the conflict, as shown at block 710.

In some examples, performing the comparison at block 708 includes performing a stepwise comparison that includes a plurality of timesteps. In some of these examples, a timestep of a plurality of timesteps, the stepwise comparison includes determining updated positions and updated velocities of the nearby moving object and the robot on respectively the predicted trajectory of the nearby moving object and the trajectory of the robot, as shown at block 712.

For the nearby moving object and the robot at respective updated positions and the updated velocities, the stepwise comparison includes determining if the nearby moving object is within a clear region that includes the robot, and if a time to closest point of approach between nearby moving object and the robot is less than a time threshold value, as shown at block 714. In some examples, the clear region is dynamic in size in that the clear region is different in size for a later one of the plurality of timesteps relative to an earlier one of the plurality of timesteps. A conflict is detected when the nearby moving object is within the clear region, and the time to closest point of approach is less than the time threshold value, as shown at block 716.

In some examples, receiving the first data at block 702 includes receiving the first data from a sensor operatively in communication with the robot and having a first data format, or data-linked from the nearby moving object and having a second data format, as shown at block 702A of FIG. 7B. In some of these examples, the first data is transformed from the first data format or the second data format to a third data format from which the vector projection and thereby the predicted trajectory of the nearby moving object is generated, as shown at block 702B.

Turning to FIG. 7C, in various examples, the first data may be applied to one or more filters before the vector projection and thereby the predicted trajectory of the nearby moving object is generated. In some examples, the first data is applied to a filter that passes the first data for generating the vector projection at block 704 only when the first position of the nearby moving object is within a given region of interest that includes the robot at the second position, as shown at block 718. In some examples, the first data further indicates a time and an accuracy of the first data, and the first data is applied to a filter that passes the first data for generating the vector projection only when the time is within a time threshold of current time, and the accuracy is within an accuracy threshold, as shown at block 720.

In some examples, the one or more nearby moving objects are a plurality of nearby moving objects, and the first data is applied to a filter that passes the first data for generating the vector projection at block 704 for only a given number of the plurality of nearby moving objects, as shown at block 722. In some of these examples including a plurality of nearby moving objects, the vector projection and thereby the predicted trajectory of the nearby moving object is generated for each nearby moving object.

In some examples, the first position and the first velocity are observations of position and velocity, and receiving the first data at block 702 includes receiving data from multiple sources including respective observations of position and velocity of the one or more nearby moving objects, as shown at block 702C of FIG. 7D. The respective observations of position and velocity are correlated; and in some examples, the respective observations have at least a threshold degree of correlation that indicates the respective observations are for the nearby moving object, as shown at block 702D. Based on this threshold degree of correlation, an observation of position and velocity is selected from the respective observations as the respectively first position and the first velocity of the nearby moving object, as shown at block 702E. In some further examples, the first data further indicates accuracies of the respective observations of position and velocity, and the observation that is selected is the observation that is most accurate as indicated by a highest one of the accuracies.

In some examples, the method 700 further includes determining at least one maneuver to avoid the conflict, as shown at block 724 of FIG. 7E. The method, then, includes causing the robot to execute the at least one maneuver, as shown at block 726.

According to example implementations of the present disclosure, the MMS 210 and its subsystems including the interface subsystem 302, situational awareness subsystem 304, mission planning subsystem 306, mission coordination subsystem 308 and mission execution subsystem 310 may be implemented by various means. Means for implementing the MMS and its subsystems may include hardware, alone or under direction of one or more computer programs from a computer-readable storage medium. In some examples, one or more apparatuses may be configured to function as or otherwise implement the MMS and its subsystems shown and described herein. In examples involving more than one apparatus, the respective apparatuses may be connected to or otherwise in communication with one another in a number of different manners, such as directly or indirectly via a wired or wireless network or the like.

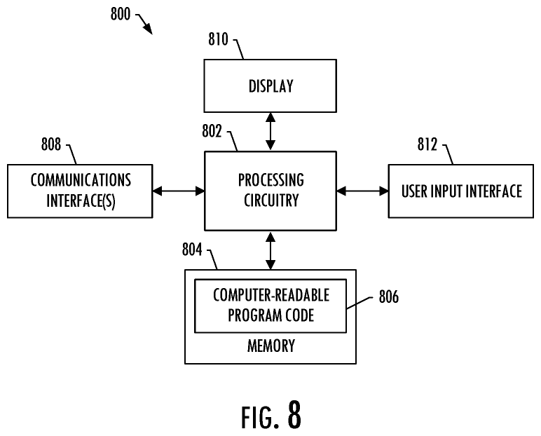

FIG. 8 illustrates an apparatus 800 according to some example implementations of the present disclosure. Generally, an apparatus of exemplary implementations of the present disclosure may comprise, include or be embodied in one or more fixed or portable electronic devices. The apparatus may include one or more of each of a number of components such as, for example, processing circuitry 802 (e.g., processor unit) connected to a memory 804 (e.g., storage device).

The processing circuitry 802 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 804 (of the same or another apparatus).

The processing circuitry 802 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 804 is generally any piece of computer hardware that is capable of storing information such as, for example, data, computer programs (e.g., computer-readable program code 806) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 804, the processing circuitry 802 may also be connected to one or more interfaces for displaying, transmitting and/or receiving information. The interfaces may include a communications interface 808 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 810 and/or one or more user input interfaces 812 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 800 may include a processing circuitry 802 and a computer-readable storage medium or memory 804 coupled to the processing circuitry, where the processing circuitry is configured to execute computer-readable program code 806 stored in the memory. It will also be understood that one or more functions, and combinations of functions, may be implemented by special purpose hardware-based computer systems and/or processing circuitry which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for detecting conflict along a route for a robot to travel, the apparatus comprising:
a memory having computer-readable program code stored therein; and
processing circuitry configured to access the memory, and execute the computer-readable program code to cause the apparatus to at least:
receive first data that indicates a first position and a first velocity of one or more nearby moving objects, or from which the first position and the first velocity of the one or more nearby moving objects are determined; and for each nearby moving object of the one or more nearby moving objects,
generate a vector projection of the nearby moving object from the first position and using the first velocity of the nearby moving object, the vector projection corresponding to a predicted trajectory of the nearby moving object;
generate a trajectory of the robot on the route for the robot to travel, and from second data that indicates a second position and a second velocity of the robot;
perform a comparison of the nearby moving object and the robot on respectively the predicted trajectory of the nearby moving object and the trajectory of the robot, the comparison performed to detect a conflict when the nearby moving object is within a clear region that includes the robot, and a time to closest point of approach between nearby moving object and the robot is less than a time threshold value; and when the conflict is detected,
output an indication of the conflict for use in at least one of guidance, navigation or control of the robot to avoid the conflict.

2. The apparatus of claim 1, wherein the route for the robot to travel is described by at least one of a route command, a flight plan or a mission route, and the apparatus caused to generate the trajectory of the robot includes the apparatus caused to generate the trajectory of the robot using the at least one of the route command, the flight plan or the mission route.

3. The apparatus of claim 1, wherein the apparatus caused to receive the first data comprises the apparatus caused to at least:
receive the first data from a sensor operatively in communication with the robot and having a first data format, or data-linked from the nearby moving object and having a second data format; and
transform the first data from the first data format or the second data format to a third data format from which the vector projection and thereby the predicted trajectory of the nearby moving object is generated.

4. The apparatus of claim 1, wherein the processing circuitry is configured to execute the computer-readable program code to cause the apparatus to further at least:
apply the first data to a filter that passes the first data for generation of the vector projection only when the first position of the nearby moving object is within a given region of interest that includes the robot at the second position.

5. The apparatus of claim 1, wherein the first data further indicates a time and an accuracy of the first data, and the processing circuitry is configured to execute the computer-readable program code to cause the apparatus to further at least:
apply the first data to a filter that passes the first data for generation of the vector projection only when the time is within a time threshold of current time, and the accuracy is within an accuracy threshold.

6. The apparatus of claim 1, wherein the first position and the first velocity are observations of position and velocity, and the apparatus caused to receive the first data comprises the apparatus caused to at least:
receive data from multiple sources including respective observations of position and velocity of the one or more nearby moving objects;
correlate the respective observations of position and velocity; and based on the respective observations having at least a threshold degree of correlation that indicates the respective observations are for the nearby moving object,
select an observation of position and velocity from the respective observations as the respectively first position and the first velocity of the nearby moving object.

7. The apparatus of claim 6, wherein the first data further indicates accuracies of the respective observations of position and velocity, and the apparatus caused to select the observation includes the apparatus caused to select the observation that is most accurate as indicated by a highest one of the accuracies.

8. The apparatus of claim 1, wherein the one or more nearby moving objects are a plurality of nearby moving objects, and
wherein the processing circuitry is configured to execute the computer-readable program code to cause the apparatus to further apply the first data to a filter that passes the first data for generation of the vector projection for only a given number of the plurality of nearby moving objects, and the vector projection and thereby the predicted trajectory of the nearby moving object is generated for each nearby moving object.

9. The apparatus of claim 1, wherein the apparatus caused to perform the comparison includes the apparatus caused to perform a stepwise comparison that includes a plurality of timesteps, and the clear region is dynamic in size in that the clear region is different in size for a later one of the plurality of timesteps relative to an earlier one of the plurality of timesteps.

10. The apparatus of claim 1, wherein the processing circuitry is configured to execute the computer-readable program code to cause the apparatus to further at least:
determine at least one maneuver to avoid the conflict; and
cause the robot to execute the at least one maneuver.

11. A method of detecting conflict along a route for a robot to travel, the method comprising:
receiving first data that indicates a first position and a first velocity of one or more nearby moving objects, or from which the first position and the first velocity of the one or more nearby moving objects are determined; and for each nearby moving object of the one or more nearby moving objects,
generating a vector projection of the nearby moving object from the first position and using the first velocity of the nearby moving object, the vector projection corresponding to a predicted trajectory of the nearby moving object;
generating a trajectory of the robot on the route for the robot to travel, and from second data that indicates a second position and a second velocity of the robot;
performing a comparison of the nearby moving object and the robot on respectively the predicted trajectory of the nearby moving object and the trajectory of the robot, the comparison performed to detect a conflict when the nearby moving object is within a clear region that includes the robot, and a time to closest point of approach between nearby moving object and the robot is less than a time threshold value; and when the conflict is detected,
outputting an indication of the conflict for use in at least one of guidance, navigation or control of the robot to avoid the conflict.

12. The method of claim 11, wherein the route for the robot to travel is described by at least one of a route command, a flight plan or a mission route, and generating the trajectory of the robot includes generating the trajectory of the robot using the at least one of the route command, the flight plan or the mission route.

13. The method of claim 11, wherein receiving the first data comprises:
receiving the first data from a sensor operatively in communication with the robot and having a first data format, or data-linked from the nearby moving object and having a second data format; and
transforming the first data from the first data format or the second data format to a third data format from which the vector projection and thereby the predicted trajectory of the nearby moving object is generated.

14. The method of claim 11 further comprising:
applying the first data to a filter that passes the first data for generating the vector projection only when the first position of the nearby moving object is within a given region of interest that includes the robot at the second position.

15. The method of claim 11, wherein the first data further indicates a time and an accuracy of the first data, and the method further comprises:
applying the first data to a filter that passes the first data for generating the vector projection only when the time is within a time threshold of current time, and the accuracy is within an accuracy threshold.

16. The method of claim 11, wherein the first position and the first velocity are observations of position and velocity, and receiving the first data comprises:
receiving data from multiple sources including respective observations of position and velocity of the one or more nearby moving objects;
correlating the respective observations of position and velocity; and based on the respective observations having at least a threshold degree of correlation that indicates the respective observations are for the nearby moving object,
selecting an observation of position and velocity from the respective observations as the respectively first position and the first velocity of the nearby moving object.

17. The method of claim 16, wherein the first data further indicates accuracies of the respective observations of position and velocity, and selecting the observation includes selecting the observation that is most accurate as indicated by a highest one of the accuracies.

18. The method of claim 11, wherein the one or more nearby moving objects are a plurality of nearby moving objects, and
wherein the method further comprises applying the first data to a filter that passes the first data for generating the vector projection for only a given number of the plurality of nearby moving objects, and the vector projection and thereby the predicted trajectory of the nearby moving object is generated for each nearby moving object.

19. The method of claim 11, wherein performing the comparison includes performing a stepwise comparison that includes a plurality of timesteps, and the clear region is dynamic in size in that the clear region is different in size for a later one of the plurality of timesteps relative to an earlier one of the plurality of timesteps.

20. The method of claim 11 further comprising:
determining at least one maneuver to avoid the conflict; and
causing the robot to execute the at least one maneuver.
